(19) United States
(12) Patent Application Publication
(10) Pub. No.: US 2007/0119062 A1
(43) Pub. Date: May 31, 2007

(54) CROWN MOLDING TOOL

(76) Inventor: Kevin Klippel, Canyon Country, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/164,519

(22) Filed: Nov. 28, 2005

(51) Int. Cl. B43L 13/00

(52) U.S. Cl. 33/481

(57) ABSTRACT

A tool for supporting crown molding during installation includes a base plate and a pair of crown molding-engaging pads slidably attached to the base plate. A handle-receiving socket is pivotally attached to the base plate.

### BACKGROUND OF THE INVENTION

The present invention generally relates to a device for assisting installation of interior decoration. More particularly, the present invention resides in a tool for installing crown molding.

Devices for installing crown molding are generally known in the art. For example, U.S. Pat. No. 6,415,520 discloses an apparatus and method for facilitating accurate placement and installation of crown molding. However, while the disclosed apparatus helps to initially align the crown molding for placement, the apparatus does nothing itself to assist in maintaining the position of the crown molding as the crown molding is being installed. It is generally well-known in the art for a person installing crown molding to hold the crown molding in place by hand while connecting the crown molding to a wall. This may be especially difficult to do for a person working by themselves while standing on a ladder. It is also known that the hand of a person working in this manner can slip during the installation process, causing the crown molding to move and result in misalignment of the crown molding. This also creates a hazard where the user can lose their balance and fall from the ladder, resulting in injury to themselves.

Accordingly, there is a need for a crown molding tool that assists a user when installing crown molding. There is a further need for a crown molding tool that reduces slippage of the crown molding during installation. There is an additional need for a crown molding tool that allows a user to maintain the position of the crown molding even when the user is standing on a floor and the crown molding is beyond arm's length of the user. There is an additional need for a tool that reduces the risk of falling that can occur when a user is installing crown molding while standing on a ladder. There is a need for a crown molding tool that is economical and easy to manufacture. The present invention fulfills these needs and provides other related advantages.

### SUMMARY OF THE INVENTION

The present invention resides in a crown molding tool that assists a user when installing crown molding and reduces slippage of the crown molding during installation. The present invention maintains the position of the crown molding even when the user is standing on a floor and the crown molding is beyond arm's length of the user. Allowing a user to hold crown molding in position while the user is standing on a floor virtually eliminates the risk of injury that can occur when a user attempts to hold crown molding in position during the installation while the user is standing on a ladder.

The present invention discloses a tool for supporting crown molding during installation that includes a base plate and a pair of crown molding-engaging pads slidably attached to the base plate. A handle-receiving socket is pivotally attached to the base plate.

The tool includes a releasable lock for holding at least one of the engaging pads between pad extended and retracted positions relative to the base plate. The lock includes a knob threadedly engaging a shank connected to the engaging pad. The shank extends through a slot of the base plate.

Each engaging pad includes a resilient non-marring surface for engaging the crown molding.

The base plate of the tool includes a channel along which a portion of the engaging pads slide.

The base plate and engaging pads share a common perimeter when the engaging pads are in a retracted position.

A handle is received within the handle-receiving socket.

Other features and advantages of the present invention will become apparent from the following more detailed description, taken in conjunction with the accompanying drawings which, by way of example, illustrate the principles of the invention.

### BRIEF DESCRIPTION OF THE DRAWINGS

The accompanying drawings illustrate the invention. In such drawings:

FIG. 1 is a perspective view of a crown molding tool embodying the present invention shown attached to a handle and being used to hold a piece of crown molding in position during installation;

FIG. 2 is a perspective view of the crown molding tool of FIG. 1 shown in a retracted configuration;

FIG. 3 is a perspective view of the crown molding tool of FIG. 1 shown in a fully extended configuration;

FIG. 4 is an exploded, perspective view of the crown molding tool of FIG. 3;

FIG. 5 is a cross-sectional, side elevation view of the crown molding tool of FIG. 2;

FIG. 6 is a cross-sectional, side elevation view of the crown molding tool of FIG. 3, illustrating pivotal movement of a handle-receiving socket of the tool; and

FIG. 7 is a close-up view of the tool where an end of the handle-receiving socket engages a base plate of the tool.

### DESCRIPTION OF THE PREFERRED EMBODIMENT

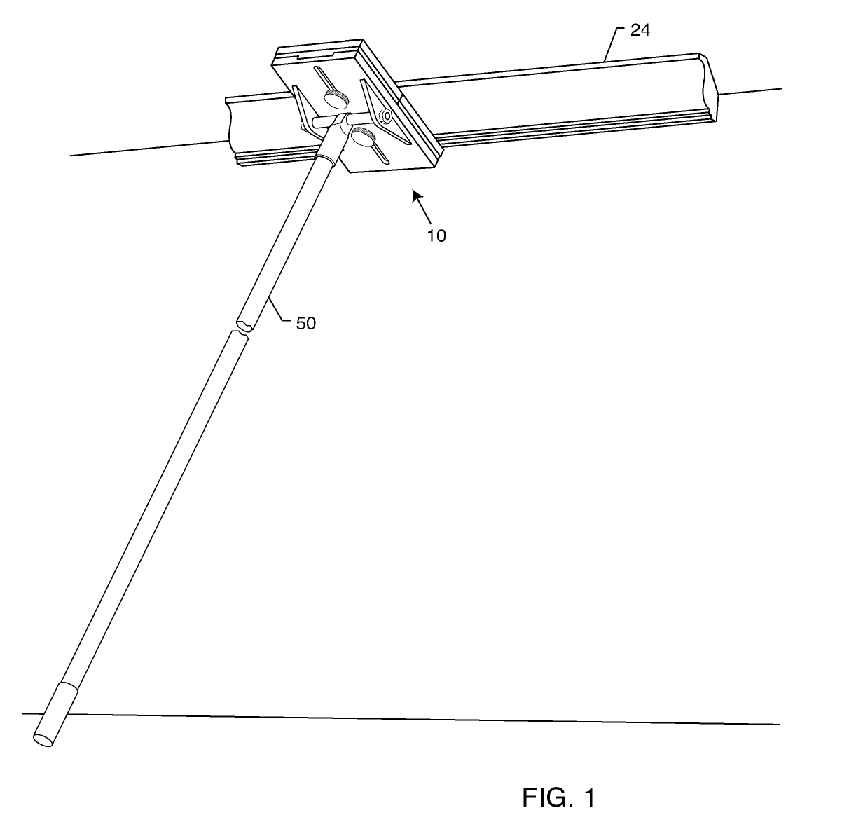

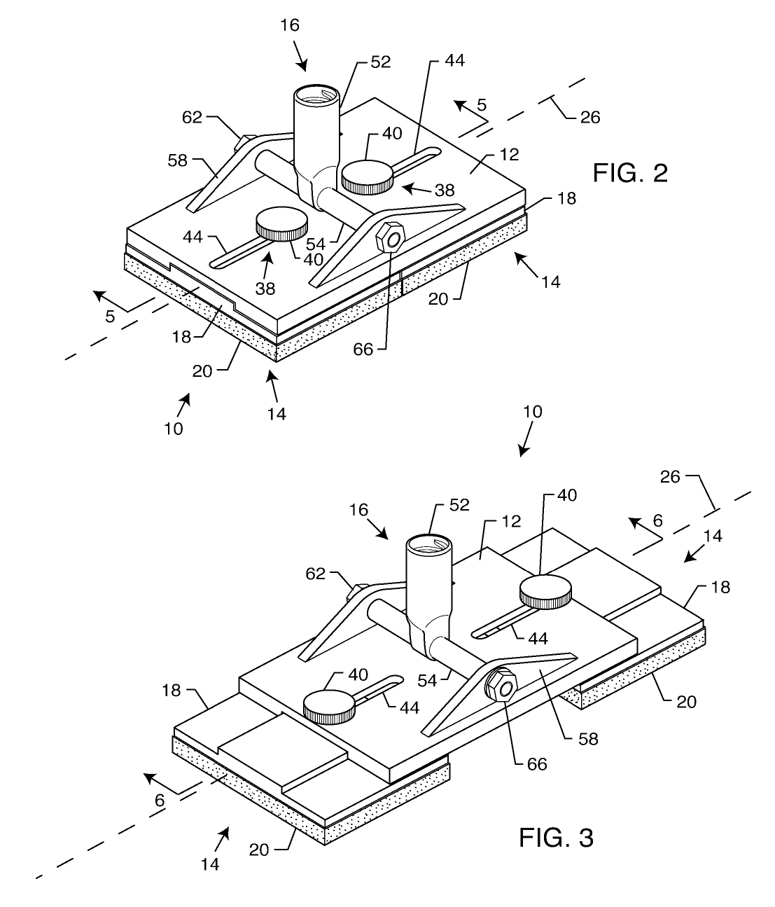

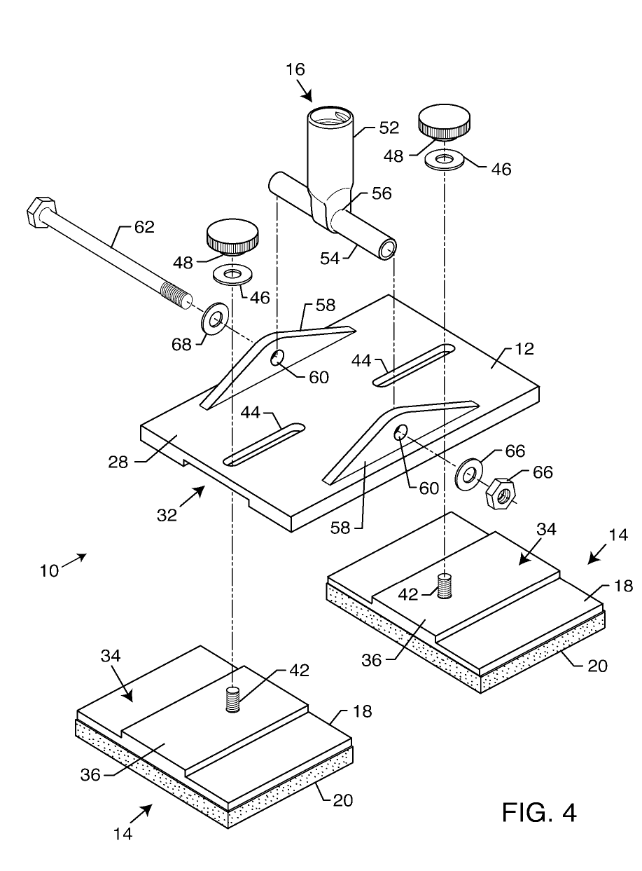

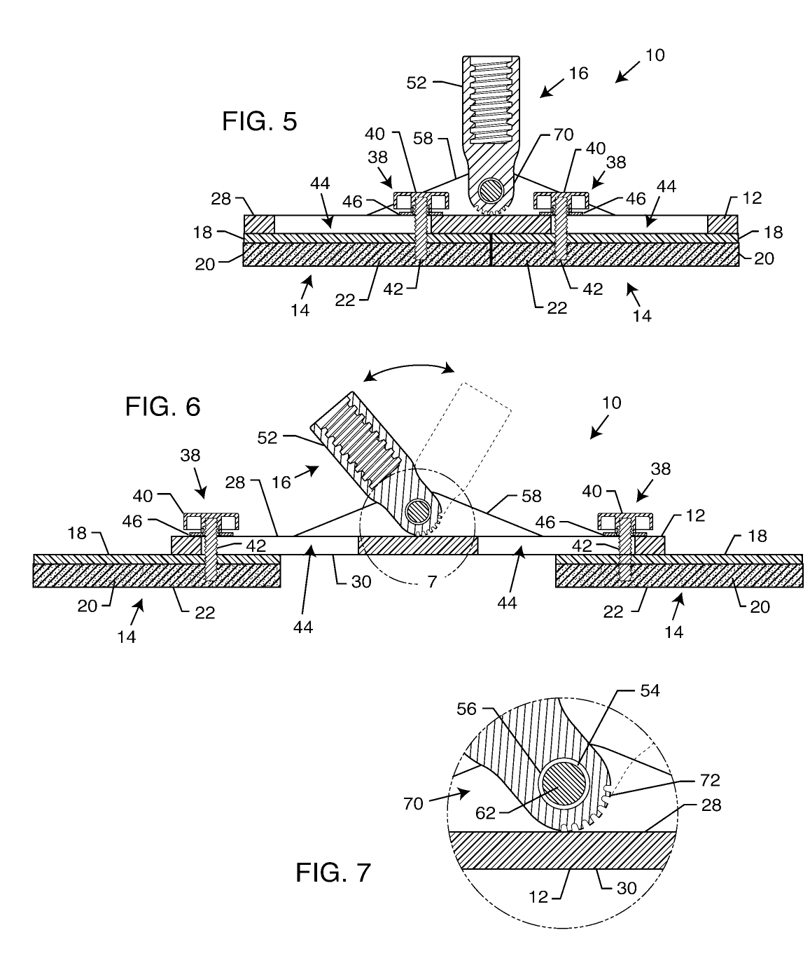

As shown in the drawings for purposes of illustration, the present invention discloses a crown molding tool 10, as seen in FIGS. 1-7. The crown molding tool 10 includes a base plate 12 and a pair of crown molding-engaging pads 14 slidably attached to the base plate 12. A handle-receiving socket 16 is pivotally attached to the base plate 12.

Each of the crown molding-engaging pads 14 includes an extension plate 18 that engages the base plate 12 and a resilient pad 20 having a non-marring surface 22 for engaging decorative surfaces of crown molding 24.

The pair of extension plates 18 are extendable away from each other and retractable towards each other as the plates 18 move relative to the base plate 12 along a common axis 26 between extended and retracted positions. The base plate 12 includes a top side 28 and a bottom side 30. A channel 32 formed on the bottom side 30 of the base plate 12 extends along the length of the base plate 12. Top surfaces 34 of the plates 18 engage the base plate 12 and raised portions 36 of the top surfaces 34 slide along the channel 32 of the base plate 12 while moving between the extended and retracted positions of the crown molding-engaging pads 14. The raised portions 36 are sized and shaped to engage the channel 32. The base plate 12 and the engaging pads 14 share a common perimeter when the engaging pads 14 are in their retracted positions.

Each of the engaging pads 14 includes a releasable locking mechanism 38. Each locking mechanism 38 holds a respective engaging pad 14 at the pad extended position, the pad retracted position, or anywhere between the pad extended and retracted positions. Each locking mechanism 38 includes a turnable knob 40 threadedly engaging a threaded shank 42 connected to the top surface 34 of the extension plate 18 of the engaging pad 14. Each shank 42 extends between the top and bottom sides 28, 30 through a respective slot 44 extending along a portion of the length of the base plate 12. A washer 46 is disposed about the shank 42 and a lower portion 48 of the knob 40, between the top side 28 of the base plate 12 and the knob 40. When one of the knobs 40 is turned in one direction to lock its respective pad 14 in place along its respective slot 44 of base plate 12, the threaded engagement of the knob 40 and shank 42 moves the base plate 12 and pad 14 towards each other until the base plate 12 and pad 14 are so tightly held together that the pad 14 is no longer able to freely slide along the channel 32 of the base plate 12. Turning the knob 40 in the other direction releases the pad 14 to slide along the channel 32.

Each resilient pad 20 is connected to its respective plate 18 by the threaded shank 42. The resilient pad 20 may also be connected to the plate 18 by an adhesive or a combination of the threaded shank 42 and adhesive. The non-marrying surface 22 may be non-textured or textured such that the surface 22 may come in various forms including, without limitation, smooth, ridged, wavy or the like. When a resilient pad 20 is worn from use, the resilient pad 20 may be replaced by a fresh resilient pad 20.

A handle pole 50 with a threaded end is received within the handle-receiving socket 16. The handle-receiving socket 16 includes a handle-engaging threaded socket 52 and a hollow sleeve 54 oriented perpendicularly to the socket 52. The socket 52 and sleeve 54 may be formed integrally as a single piece or an end 70 of the socket 52 includes a hollow bore 56 through which the sleeve 54 may be inserted. The base plate 12 includes two flanges 58 extending upwardly from the top side 28 of the base plate 12 with the slots 44 disposed between the two wedges 58. Each flange 58 includes a bore 60 that the hollow sleeve 54 is aligned with. An elongated threaded bolt 62 is inserted through the bore 60 of one of the flanges 58, into the hollow sleeve 54, and out through the bore 60 of the other flange 58. A washer 64 and threaded nut 66 are used to secure the bolt 62 in place with the washer 64 being disposed about the shank of the bolt 62, between the flange 58 and the nut 66. Another washer 68 is disposed about the shank of the bolt 62 between the head of the bolt 62 and the flange 58 that the head of the bolt 62 is adjacent to. The securement of the handle-receiving socket 16 in the manner allowed the handle-receiving socket 16 to pivot relative to the base plate 12. The exterior surface of the end 70 of the socket 52 forms a pivotal locking mechanism that includes a plurality of teeth or ridges 72 that engage the top side 28 of the base plate 12 in a manner that allows the handle-receiving socket 16 to be held at a number of pivotal orientations at and/or between zero and one hundred eighty degrees with respect to the base plate 12.

In the alternative, the resilient pad 20 may be connected to the plate 18 by a threaded bolt (not shown) that sits within a recessed bore (not shown) extending through the resilient pad 20 in order to engage the knob 40 associated with that resilient pad 20.

While the crown molding tool 10 has been described in terms of use with crown molding 24, the tool 10 is can also be used with other objects to be held in position including, without limitation, portrait frames, shelving or the like.

The above-described embodiment of the present invention is illustrative only and not limiting. It will thus be apparent to those skilled in the art that various changes and modifications may be made without departing from this invention in its broader aspects.

What is claimed is:

1. A tool for supporting crown molding during installation, comprising:
a base plate;
a pair of crown molding-engaging pads slidably attached to the base plate; and
a handle-receiving socket pivotally attached to the base plate.

2. The tool of claim 1, including a releasable lock for holding at least one of the engaging pads between pad extended and retracted positions relative to the base plate.

3. The tool of claim 2, wherein the lock includes a knob threadedly engaging a shank connected to the engaging pad.

4. The tool of claim 3, wherein the shank extends through a slot of the base plate.

5. The tool of claim 1, wherein each engaging pad includes a resilient non-marring surface for engaging the crown molding.

6. The tool of claim 1, wherein the base plate includes a channel along which a portion of the engaging pads slide.

7. The tool of claim 1, including a handle received within the handle-receiving socket.

8. The tool of claim 1, wherein the base plate and engaging pads share a common perimeter when the engaging pads are in a retracted position.

9. A tool for supporting crown molding during installation, comprising:
a base plate;
a pair of crown molding-engaging pads slidably attached to the base plate;
a handle receiving socket pivotally attached to the base plate; and
a releasable lock for holding at least one of the engaging pads between extended and retracted positions relative to the base plate;
wherein the base plate and engaging pads share a common perimeter when the engaging pads are in the retracted position.

10. The tool of claim 9, wherein the lock includes a turnable knob threadedly engaging a shank connected to the engaging pad.

11. The tool of claim 10, wherein the shank extends through a slot of the base plate.

12. The tool of claim 9, wherein each engaging pad includes a resilient non-marring surface for engaging the crown molding.

13. The tool of claim 9, wherein the base plate includes a channel along which a portion of the engaging pads slide.

14. The tool of claim 9, including a handle received within the handle-receiving socket.

15. A tool for supporting crown molding during installation, comprising:
a base plate;
a pair of crown molding-engaging pads slidably attached to the base plate, wherein each engaging pad includes a resilient non-marring surface for engaging the crown molding;
a handle receiving socket pivotally attached to the base plate; and
a releasable lock for holding each of the engaging pads between extended and retracted positions relative to the base plate;
wherein the base plate includes a channel along which a portion of the engaging pads travel as the engaging pads slide, and wherein the base plate and engaging pads share a common perimeter when the engaging pads are in the retracted position.

16. The tool of claim 15, wherein each lock includes a turnable knob threadedly engaging a shank connected to the engaging pad, and wherein the shank extends through a slot of the base plate from one side of the base plate to engage the knob on an opposite side of the base plate.

17. The tool of claim 15, including a handle received within the handle-receiving socket.
